(19) United States
(12) Patent Application Publication
(10) Pub. No.: US 2007/0014955 A1
(43) Pub. Date: Jan. 18, 2007

(54) Printable polylactide film material, methods and labels made therefrom

(75) Inventor: Chris John Tanley, Green Bay, WI (US)

Correspondence Address: Dale A. Bjorkman;Kagan Binder, PLLC, Maple Island Building, Suite 200, 221 Main Street North, Stillwater, MN, 55082, US

(73) Assignee: Green Bay Packaging Inc.

(21) Appl. No.: 11/181,209

(22) Filed: Jul. 14, 2005

(51) Int. Cl. B32B 33/00

(52) U.S. Cl. 428/40.1

(57) ABSTRACT

Polylactide films are provided with a printable major surface by increasing the surface energy of a major surface of the polylactide film to a surface energy of at least about 48 dynes. Film products of the present invention can be printed on an industrial scale with excellent print durability. Films, methods of treating, adhesive composites and methods of making are provided using these films.

### FIELD OF THE INVENTION

The present invention relates to printable polylactide film materials. More specifically, the present invention relates to polylactide films that are printable and preferably can be used to prepare pressure sensitive labels therefrom.

### BACKGROUND OF THE INVENTION

Concern for the environment, and in particular in the use of fossil fuel based materials that do not degrade after having been disposed of in landfills, has lead to a desire to develop films from renewable materials that will harmlessly degrade under landfill conditions. To this end, product development efforts by manufacturers has lead to the development of film materials that are both made from renewable materials and also are physically degradable.

To this end, biodegradable and compostable cellulose films, such as NatureFlex™ film from Innovia Films (formerly UCB Films) has been developed, which comprises a base film derived from wood pulp with specialty barrier coatings used to refine its permeability. Similarly, materials have been developed that are derived at least in part from corn. Thus, a melt-stable lactide polymer composition as developed by Cargill, Incorporated is described in U.S. Pat. No 5,338,822 to Gruber, et. al, and in related applications. This lactide polymer composition can be melt-processed to produce useful articles such as thin films, packaging materials, coated papers, non-woven articles and any other useful article that may be molded or extruded from the resin. Other configurations of lactide polymer-containing construction are described, such as in U.S. Pat. No. 5,849,401. This patent discloses a compostable multilayer film that includes a core layer having a first surface and a second surface, a first blocking reducing layer covering the first surface of the core layer, and a second blocking reducing core layer comprises a lactic acid residue-containing polymer having a glass transition temperature (Tg) below 20° C. The first and second blocking reducing layers comprise a semicrystalline aliphatic polyester. The multilayer structure can be used for preparing bags and wrappers.

In general, polymer films and objects have chemically inert and non-porous surfaces with low surface tensions, causing them to be non-receptive to bonding with substrates, printing inks, coatings, and adhesives. In order to provide a surface that is receptive to printing, film surface pretreatments have been developed to provide the higher surface energy required produce quality printed, coated or laminated products. For example, the surface energy of plastic films, foils and paper has been increased by use of corona treatment in order to allow improved wettability and adhesion of inks, coatings and adhesives. Such treated materials will demonstrate improved printing and coating quality, and stronger lamination strength. Corona treatment is a common method used to increase the surface energy of plastic by means of a high voltage electrical discharge, thus improving its wettability and adhesion characteristics for printing and laminating.

The principles of treating a surface to have the proper surface energy characteristics are discussed at www.accudvnetest.com/qctest.html. According to this source, if the substrate surface energy does not significantly exceed the surface tension of the fluid which is to cover it, wetting will be impeded and a poor bond will result. Thus, for most solvent based printing, plastics need to be treated to 36 to 40 dynes/cm; water based inks usually require 40 to 44 dynes/cm. It is noted that some laminating and coating applications require surface energies of 50 dynes/cm or more.

A patent related to multilayer compostable structures, U.S. Pat. No. 6,121,410, describes poly(lactide) films for use in articles such as diapers, packaging film, agricultural mulch film, bags and tape. This patent states that:

The surface energy of substantially pure poly(lactide) films of the present invention is about 44 dynes/cm. This leads to a surface with satisfactory printing characteristics without surface modification. Slip aids or other additives may reduce the surface energy down to about 35 dynes/cm. Additionally, inks which are typically more difficult to apply onto films, like water based inks, may be applied directly to poly(lactide). See column 6, line 65—column 7, line 5. This same paragraph also appears in U.S. Pat. No. 6,207,792, which relates to amorphous polylactide polymers. Thus, according to these patents, the surface energy of poly(lactide) films are printable without surface modification.

### SUMMARY OF THE INVENTION

It has surprisingly been found that, contrary to conventional expectations and repeated assertions in the art, a conventional polylactide polymer film surface is not a satisfactory print receptive surface for desired commercial printing operations. The present invention therefore provides a method of providing a polylactide film having a printable major surface. This method comprises providing a polylactide film having a major surface, and increasing the surface energy of the major surface of the polylactide film to a surface energy of at least about 48 dynes to provide a printable major surface.

In another aspect of the present invention, a polylactide film is provided having a printable major surface. The film has a first and second major surface, and the first major surface has a surface energy of at least about 48 dynes. Methods are also described, wherein this film is printed on at least a portion of the first (i.e. the printable) major surface of the polylactide film with a printing ink.

In another aspect of the present invention, an adhesive label is provided comprising a face material comprising the polylactide film having a printable major surface as described above. The face material has first and second major surfaces, and the first major surface having a surface energy of at least about 48 dynes. A pressure sensitive adhesive is provided on the second surface of the face material, and a release liner is provided on the pressure sensitive adhesive.

In another aspect of the present invention, a method of manufacturing an adhesive label composite is provided. In this method, a release liner is provided, and is coated with a pressure sensitive adhesive. A polylactide film face stock having first and second major surfaces is also provided, wherein the first major surface has a surface energy of at least about 48 dynes. The second surface of the polylactide film face stock is laminated to the pressure sensitive adhesive on the release liner to provide the adhesive label composite.

The present invention makes it possible to readily provide printed biodegradable film products having highly desirable film properties that can be printed on an industrial scale with excellent print durability. Additionally, the printable polylactide film as described herein can advantageously be printed by a wide variety of conventional printing inks, including ultraviolet ink, solvent based ink and water-based ink. This enhanced flexibility in ink choices greatly benefits the printer and, ultimately, the consumer.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is an edge view of a composite of and adhesive composite of the present invention.

FIG. 2 is a perspective view of an adhesive label composite of the present invention.

### DETAILED DESCRIPTION

Polylactide films used in the present invention can be, for example, polymer films described in U.S. Pat. Nos. 5,338,822; 5,849,401; 6,121,410; and 6,207,792, as well as other patents and publications. A preferred film for use in the present invention is the crystal film manufactured for NatureWorks™ under the name “PLA” film. PLA film is a 1.6 mil film derived from corn.

Alternatively, the polylactide film may be provided as a multilayer structure, preferably made of materials that are all compostable. Preferably, the multilayered construction comprises layers formed from hydrolyzable polymers. Exemplary hydrolyzable polymers include copolymers and polymer blends of poly(trimethylene carbonate) and polyesters such as poly(lactic acid), poly(lactide), poly(glycolide), poly(hydroxy butyrate), poly(hydroxy butyrate-co-hydroxy valerate), poly(caprolactone), poly(ethylene-oxylate), poly(1,5-dioxepan 2-one), poly(1,4-dioxepan 2-one), poly(p-dioxanone), poly(delta-valerolactone), polyethylene(oxylate), polyethylene(succinate), polybutylene(oxalate), polybutylene(succinate), polypentamethyl(succinate), polyhexamethyl(succinate), polyheptamethyl(succinate), polyoctamethyl(succinate), polyethylene(succinate-co-adipate), polybutylene(succinate-co-adipate), polybutylene(oxylate-co-succinate), polybutylene(oxylate-co-adipate), epoxidized multifunctional oil, such as soybean oil or linseed oil and blends thereof. Aliphatic polyesters are preferred because of their ability to hydrolyze to generally biodegradable units.

In certain embodiments, the polylactide film may comprise additional layers, such as blocking reducing layers can include anti-blocking agents to reduce blocking. Exemplary anti-blocking agents include poly(hydroxy butyrate co hydroxy valerate), cellulose acetate, cellulose propionate, cellulose butyrate, cellulose acetate propionate, cellulose acetate butyrate, cellulose propionate butyrate, and mixtures thereof.

The polylactide film may be formed, for example, from an extruded melt by any of several means. The structure may be cast and quenched, either onto a drum, a belt, in water, or the like. The cast film may be subsequently oriented, either uniaxially or biaxially, using conventional equipment such as drawing on heated rollers or using a tenter-frame, or a combination thereof. The processing operation may also include crystallization (of the outer layers) and/or heat-setting of the film. The biaxially oriented film can also be subjected to additional drawing of the film in the machine direction, in a process known as tensilizing.

The film may also be processed in a blown-film apparatus, in order to achieve direct biaxial orientation directly from the melt or in a double-bubble process. The blown-film process is known in the art, as is the double-bubble process. In the blown film process the annular tube is inflated as it leaves the extruder and is cooled with an air ring, prior to collapsing and winding. The double-bubble process first quenches the tube, it is then reheated and oriented by inflating at a temperature above the Tg but below the crystalline melting point (if the polymer is crystalline).

In an embodiment of the present invention, a plurality of layers may be provided to form a multilayer film structure. The layers may be provided, for example, by coextruding layers of polymer compositions. Preferably, all layers of the construction are compostable or biodegradable.

The polylactide film is then treated in a manner to increase the surface energy of a major surface of the polylactide film to a surface energy of at least about 48 dynes. In a preferred embodiment, the surface energy is increased to at least about 50 dynes. The surface energy of a surface of the polylactide film is determined in accordance with ASTM Std. D25781.

The surface energy of the polylactide film is preferably increased by corona treatment. Corona treatment can be carried out by conventional (dielectric covered roll) corona treatment systems or bare-roll (dielectric covered electrode) corona treatment systems.

Alternatively, the surface energy of the polylactide film is increased by flame treatment or cold plasma treatment. In flame treatment, an ionized airstream is induced, which alters the surface as it impinges upon it. This is accomplished by burning an ultra-lean gas mixture, whose excess oxygen is rendered reactive by the high temperature. In cold plasma treatment, a selected gas is introduced into an evacuated chamber and ionized by a radio frequency (rf) field. The rf field excites the gas molecules, creating a blend of neutral atoms and reactive radicals formed from free electrons. When these free radicals bombard the surface, the outer molecular layer of the structure can be removed, long-chain molecules can be crosslinked, and the surface energy of the surface is increased.

As noted above, treated polylactide films that have been printed with an ink exhibit superior durability as compared to non-treated films. Print durability of printed materials is evaluated in accordance with ASTM D 3359-02, in one embodiment using 3M 600 tape, and in another embodiment using 3M 610 tape.

As noted above, the film can be printed with any appropriate ink, including ultraviolet ink, solvent based ink and water-based ink. Further, the ink may advantageously be readily printed by a wide variety of printing processes, such as letter offset, gravure, screen printing, ink jet, thermo, piezo, flexographic and lithographic printing processes. The surprising receptivity of the treated polylactide films as described herein provides exceptional flexibility to the printer in choosing a process that is most favorable in providing the desired end product.

Preferably, printing with an ink takes place within 90 days of treatment of the polylactide film to increase the surface energy of the film. While not being bound by theory, it is believed that the surface energy characteristic as imparted to a polylactide film is of limited duration, and therefore printing while the surface energy is at the indicated level is important. Surprisingly, the durability of the ink on the polylactide surface remains high over time if printed when the polylactide film is at the indicated surface energy level, even after reduction of the measurable surface energy level below 48 dynes over time. In a particularly preferred embodiment, printing with an ink takes place within 10 days of treatment of the polylactide film to increase the surface energy of the film. In another particularly preferred embodiment, the printing step and the surface energy increasing step take place sequentially as in-line processes.

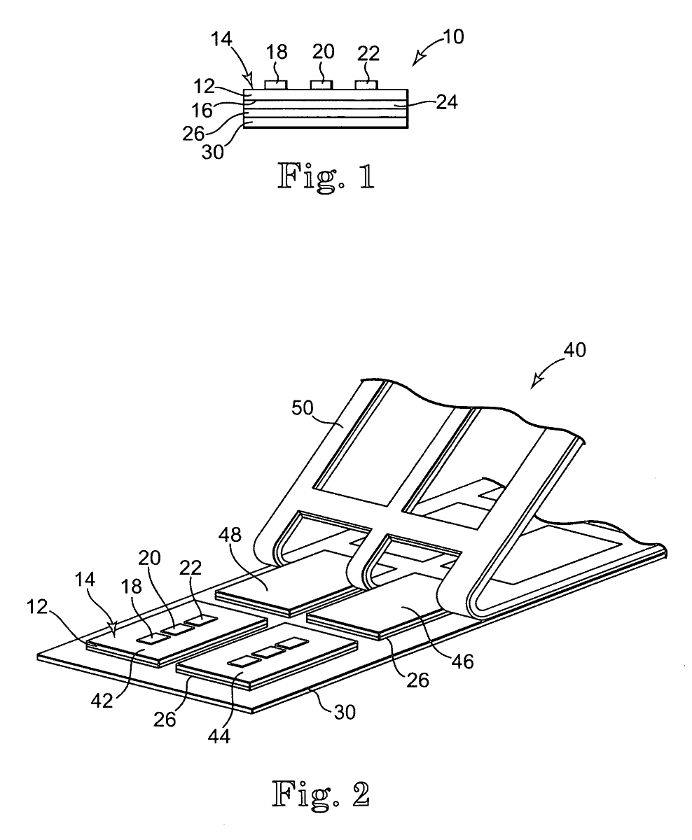

Turning now to the drawings, wherein like numbers represent like parts, FIG. 1 is an adhesive composite 10 comprising polylactide film 12 having first major surface 14 and second major surface 16. First major surface 14 has been treated to provide a surface energy of at least about 48 dynes. Ink 18, 20 and 22 is printed on first major surface 14. Advantageously, ink 18, 20 and 22 will durably adhere to first major surface 14 without the use of a primer layer or other intermediate layer. Alternatively, a primer layer or other intermediate layer could be used to provide additional properties, in which case the adhesion of the primer or additional layer will be enhanced due to the surface treatment of first major surface 14.

Optional anchor coat 24 is provided on second major surface 16 to modify the surface adhesion properties of second major surface 16 if desired. Second major surface 16 is optionally surface treated to enhance the adhesion of anchor coat 24 to second major surface 16 if desired.

Pressure sensitive adhesive 26 is provided on second major surface 16, with an intervening layer of optional anchor coat 24 located therebetween. The designation “on” as used herein is a positional definition, and does not require that the stated members be in intimate contact.

The adhesive may be selected from any material suitable for use with polylactide film of the present invention. Preferably, the adhesive is a pressure sensitive adhesive having sufficient tackiness to adhere to a substrate if the label is to be permanently adhered to the substrate. The adhesive of a particularly preferred embodiment has sufficient tackiness and internal cohesion to be removably adhered to the desired substrate. For purposes of the present invention, an adhesive is considered to be “removable” if the adhesive coated article can be applied and adhered to a substrate and then removed (generally within 24 hours) without distorting, defacing, or destroying the backing, adhesive, or substrate. When the adhesive coated article is applied to a cotton t-shirt, for example, the article can be removed with minimal fiber removal, and with minimal adhesive residue remaining on the cotton fabric. For purposes of the present invention, an adhesive considered to be “repositionable” if the adhesive coated article can be applied and adhered to a substrate and then removed (generally within 24 hours) and reapplied without distorting, defacing, or destroying the backing, adhesive, or substrate, and if the peel force of the second removal of the article from the substrate is at least about 50% of the peel force of the initial removal of the article from the substrate. Preferred substrates for evaluation of repositionability are washed cotton t-shirt materials and white bond 20 pound xerographic quality paper. The preferred evaluation is carried out by applying the article using a 5 lb, 3.25 inch diameter, rubber coated roller, rolled over the article once, and removal using a 90 degree pull at a rate of 90 inches per minute.

Examples of suitable adhesives include acrylic and styrene-butadiene adhesives, although any adhesive meeting the general criteria provided may be employed in the present invention. In one embodiment, the adhesive is a water-based or solvent-based acrylic adhesive. In another embodiment, the adhesive is a water-soluble or water dispersible adhesive, in order to provide a more readily recyclable or biodegradable adhesive coated article. In embodiments where the label is clear, preferably a clear adhesive is used.

Release liner 30 is provided on pressure sensitive adhesive 26 to provide removable protection of the pressure sensitive adhesive. Thus, the adhesive composite 10 can be manufactured and transported to a desired location, with release liner 30 being subsequently removed. The composite can then be applied to a desired substrate, and adhered thereto by the exposed pressure sensitive adhesive 26.

The release liners may be selected from any material suitable for removably protecting the pressure sensitive adhesive of the label. Release liner materials are well known and are commercially available from a number of sources. Nonlimiting examples of release liners include release liners selected from polyethylene, polypropylene, or polyester release liners. Additional nonlimiting examples of release liners include release liners selected from Kraft paper, polyethylene coated paper or polymeric materials coated with polymeric release agents selected from silicone, silicone urea, urethanes, and long chain alkyl acrylate release agents. Examples of polymeric release agent coatings are described in U.S. Pat. Nos. 3,957,724; 4,567,073; 4,313,988; 3,997,702; 4,614,667; 5,202,190; and 5,290,615; the disclosures of which are incorporated by reference herein. Examples of commercially available liners include Polyslik™ brand liners from Rexam Release of Oakbrook, Ill., USA and EXHERE™ brand liners from P.H. Glatfelter Company of Spring Grove, Pa., USA.

In an alternative embodiment, the film can be laminated to an additional material, such as a compostable material, to provide structural support or for other physical properties, with or without a pressure sensitive adhesive.

FIG. 2 is a perspective view of an adhesive label composite 40 of the present invention. As shown, polylactide film 12 has first major surface 14, that has been treated to provide a surface energy of at least about 48 dynes. Ink 18, 20 and 22 is printed on first major surface 14. Polylactide film 12 is die cut to form individual labels 42, 44, 46 and 48, and matrix 50. Matrix 50 is shown being removed from release liner 30 to provide a composite wherein individual labels 42, 44, 46 and 48 are provided on release liner 30. Printing of polylactide film 12 preferably takes place prior to removal of matrix 50, but optionally can also take place after removal of matrix 50.

The following examples describe preferred embodiments of the invention. Other embodiments within the scope of the claims herein will be apparent to one skilled in the art from consideration of the specification or practice of the invention as disclosed herein.

### EXAMPLES

### Example 1. (Comparative)

A polylactide film commercially available from NatureWorksTM as NatureWorksTM PLA was measured to have a surface energy of 40-42 dynes by the method set forth in ASTM Std. D25781. This film was printed with conventional UV flexo printing ink, and evaluated for printing durability by the method set forth in ASTM D 3359-02, using 3M 600 tape. This film failed the durability test, with a classification of 0B, meaning that greater than 65% of the ink was removed under this test.

### Example 2

The polylactide film commercially available from NatureWorksTM as NatureWorksTM PLA as described in Example 1 was corona treated, and then measured to have a surface energy of 49-52 dynes by the method set forth in ASTM Std. D25781. This film was printed with conventional UV flexo printing ink, and evaluated for printing durability by the method set forth in ASTM D 3359-02, using 3M 600 tape. This film passed the durability test, with a classification of 5B, meaning that none of the ink was removed under this test.

### Example 3

The polylactide film commercially available from NatureWorksTM as NatureWorksTM PLA as described in Example 1 was corona treated, and then measured to have a surface energy of 49-52 dynes by the method set forth in ASTM Std. D25781. This film was printed with conventional UV flexo printing ink, and evaluated for printing durability by the method set forth in ASTM D 3359-02, using 3M 610 tape. This film passed the durability test, with a classification of 5B, meaning that none of the ink was removed under this test.

All patents, patent documents, and publications cited herein are incorporated by reference as if individually incorporated. Unless otherwise indicated, all parts and percentages are by weight. The foregoing detailed description has been given for clarity of understanding only. It will be appreciated that numerous modifications and variations of the invention are possible in light of the above teachings, and therefore the invention may be practiced otherwise than as particularly described.

What is claimed:

1. A method of providing a polylactide film having a printable major surface, comprising
a) providing a polylactide film having a major surface, and
b) increasing the surface energy of the major surface of the polylactide film to a surface energy of at least about 48 dynes to provide a printable major surface.

2. The method of claim 1, wherein the surface energy is increased to at least about 50 dynes.

3. The method of claim 1, wherein the surface energy is increased by corona treatment.

4. The method of claim 1, wherein the surface energy in increased by flame treatment or cold plasma treatment.

5. The method of claim 1, wherein the printable major surface of the polylactide film does not additionally comprise a primer layer.

6. A polylactide film having a printable major surface, the film having a first and second major surface, wherein the first major surface has a surface energy of at least about 48 dynes.

7. The printable polylactide film of claim 6, wherein the film is laminated to a compostable material.

8. A method of printing a polylactide film surface, comprising
a) providing a polylactide film having a printable major surface of claim 6; and
b) printing at least a portion of the first major surface of the polylactide film with a printing ink.

9. The method of claim 8, wherein the printing step takes place within 90 days of the surface energy increasing step.

10. The method of claim 8, wherein the printing step takes place within 10 days of the surface energy increasing step.

11. The method of claim 8, wherein the printing step and the surface energy increasing step take place sequentially as in-line processes.

12. An adhesive label comprising
a) a face material comprising a polylactide film of claim 6, said face material having first and second major surfaces, the first major surface having a surface energy of at least about 48 dynes;
b) a pressure sensitive adhesive on the second surface of the face material; and
c) a release liner on the pressure sensitive adhesive.

13. The adhesive label of claim 12, further comprising an anchor coat between the pressure sensitive adhesive and the second surface of the face material;

14. A method of manufacturing an adhesive label composite, comprising:
a) providing a release liner;
b) coating a pressure sensitive adhesive on the release liner;
c) providing a polylactide film face stock having first and second major surfaces, the first major surface having a surface energy of at least about 48 dynes; and
e) laminating the second surface of the polylactide film face stock to the pressure sensitive adhesive on the release liner.

15. The method of claim 14, further comprising die cutting the polylactide film face stock to form individual labels and a matrix from the face stock.

16. The method of claim 15, further comprising removing the matrix from the adhesive label composite.

17. The method of claim 14, further comprising printing at least a portion of the printable major surface of the polylactide film with a printing ink.

18. The method of claim 14, wherein the second surface of the polylactide film face stock has an anchor coat thereon prior to laminating the second surface of the polylactide film face stock to the pressure sensitive adhesive on the release liner.
